(19) United States
(12) Patent Application Publication
(10) Pub. No.: US 2007/0064904 A1
(43) Pub. Date: Mar. 22, 2007

(54) System and method for patron notification using the patron's wireless device

(75) Inventor: Robert J. Wesley, Wellesley, MA (US)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Vayusa, Inc., Newton, MA (US)

(21) Appl. No.: 11/102,544

(22) Filed: Apr. 8, 2005

(51) Int. Cl. H04M 3/42

(52) U.S. Cl. 379/207.02

(57) ABSTRACT

There is disclosed a system in which the patron's own telephone, or other wireless device, is used to inform the patron that a service for which the patron is waiting has become available. Once the patron's wireless device becomes registered with the service provider, informational messages of interest to that patron can be provided to the patron. These informational messages can be displayed on the screen of the wireless device or can be delivered to the patron audibly. In some situations, the patron's wireless device can be used for two-way communication with the service provider in order to, for example, answer a question or place an order. In one embodiment, the calling number of the patron's wireless device is entered into the system electronically, for example, using RFID or NF communication.

### RELATED APPLICATIONS

This application is related to co-pending and commonly assigned U.S. patent application Ser. No. 10/646,579, filed Aug. 22, 2003, entitled “SYSTEM AND METHOD OF INTEGRATING LOYALTY/REWARD PROGRAMS WITH PAYMENT IDENTIFICATION SYSTEMS,” and Ser. No. 10/877,276, filed Jun. 25, 2004, entitled “SYSTEM AND METHOD FOR COORDINATING PAYMENT IDENTIFICATION SYSTEMS,” the disclosures of which are hereby incorporated herein by reference.

### TECHNICAL FIELD

This invention relates to notification systems and more particularly to such systems and methods in which a patron registers the patron's own wireless device pending a commercial transaction in which the patron receives messages while awaiting the pending transaction to be completed.

### BACKGROUND OF THE INVENTION

It has become commonplace when waiting for a table at a restaurant for the host/hostess to hand the patron a wireless device. When the wireless device begins to pulsate/flash the patron knows his/her table is ready. Such systems have obviated the need for loudspeakers to announce the names of patrons.

While such systems have proven to be popular, both with patrons and with restaurants and other establishments where such systems are employed, they are expensive to maintain due primarily to maintenance of the wireless receivers as well as the fact that they tend to disappear. One solution to this problem has been addressed in U.S. Pat. No. 6,542,751 dated Apr. 1, 2003 which patent is hereby incorporated by reference herein.

The '751 patent is directed to a dual system (called multi-mode) in which the establishment can use either a local pager system or the patron's own wireless device, such as a pager, cellular telephone, PDA, computer, etc. to page the patron. While the '751 patent helps reduce the problems inherent with local pager systems, it still relies on the local system for its foundation. In addition, the system described in the '751 patent does not address all of the issues associated with patrons waiting in queues for service.

### BRIEF SUMMARY OF THE INVENTION

There is disclosed a system in which the patron's own telephone, or other wireless device, is used to inform the patron that a service for which the patron is waiting is now available. Once the patron's wireless device becomes registered with the service provider informational messages of interest to that patron are provided to the patron. These informational messages can be displayed on the screen of the wireless device or can be delivered to the patron audibly via the patron's device. In some situations, the patron's wireless device can be used for two-way communication with the service provider in order to, for example, answer a question or place an order.

In one embodiment, the patron provides the calling number of his/her wireless device to the host/hostess who then enters the number into the service provider's pager system. The system provides the host/hostess with a control identification and when the table (or other service) is ready the host/hostess then enters the control identification into the system and the system dials the wireless device of the patron and provides an oral, text or graphics message to the patron, using either a paging mode, a call placement mode, or a data transfer mode.

In another embodiment, the calling number of a patron's wireless device is entered by bringing the wireless device into proximity to a service provider registration point. Registration of the wireless number can also serve to place the patron in the queue. If a reservation had been made that had been keyed to the patron's calling number, the registration of the calling number could then serve to notify the service provider that the party has arrived.

In a still further embodiment, the calling number can be linked to a payment system such that the patron can have the cost of the dinner (or other product) charged to a credit facility under control of inputs from the patron's wireless device.

In a still further embodiment, the patron can be remotely located from the service provider and the wireless message used to inform the patron that a service is now available to the patron.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIGS. 1, 2A and 2B show embodiments of the invention used in different environments;

FIG. 3 shows one embodiment of a process illustrating number registration;

FIG. 4 shows one embodiment of a process illustrating patron message control.

### DETAILED DESCRIPTION OF THE INVENTION

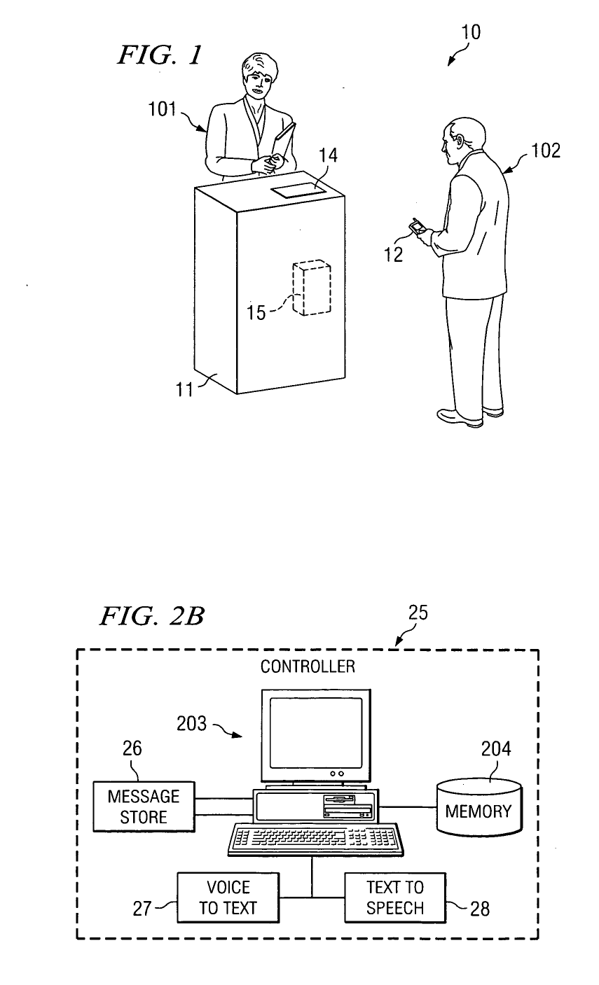

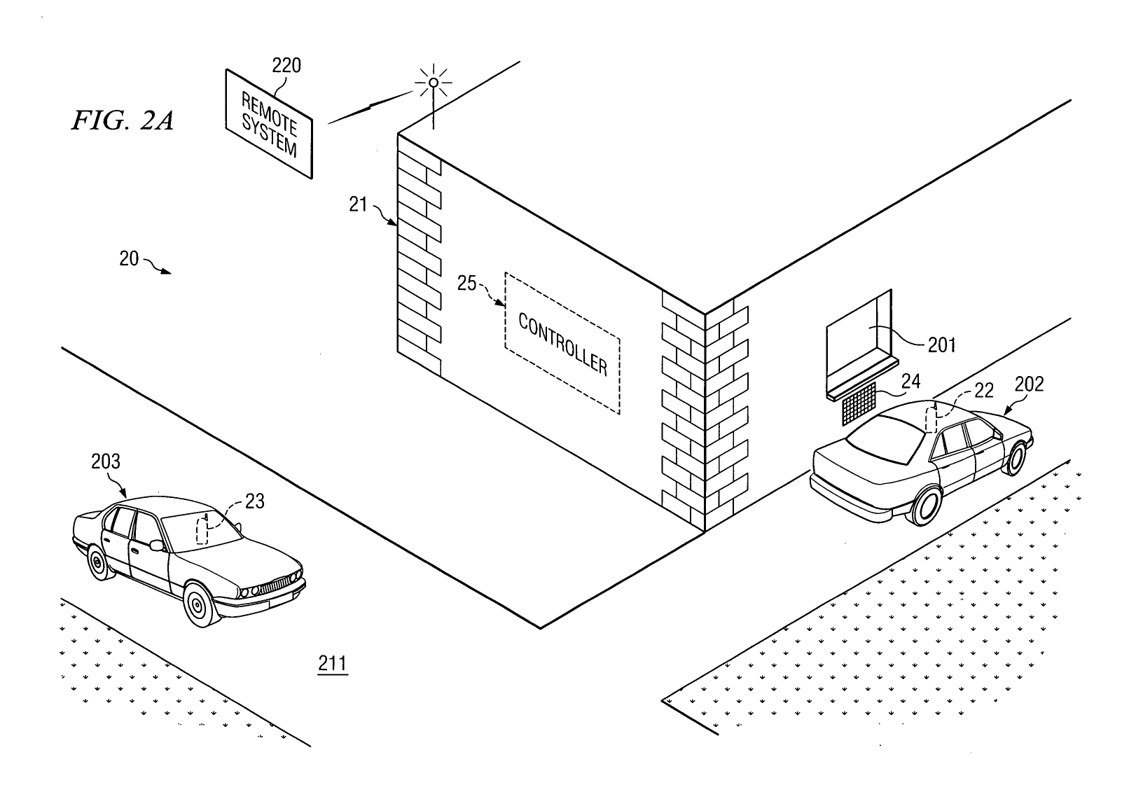

FIG. 1 shows one embodiment 10 of a system in which patron 102 with a wireless device, such as cellular telephone 12, approaches podium 11 of a restaurant where host/hostess 101 is positioned. Not shown are the plurality of other patrons mingling around awaiting a table to become available. In the embodiment shown, host/hostess 101 enters an identification number (such as the calling number) of wireless device 12 into controller 15 in any one of a number of ways. The identification number could be spoken or it could be Radio Frequency Identification (RFID), Near-Field (NF) transferred via wireless device 12 via receiving device 14. Controller 15 is essentially the same as controller 25 as will be discussed in more detail hereinafter with respect to FIG. 2B.

In one embodiment, control number is provided to host/hostess 101 by controller 15 or alternatively host/hostess 101 provides the control number for use by controller 15. This control number is then stored in a memory in association with the calling identification number of the patron's wireless device.

When the table for patron 102 becomes available, host/hostess 101 inputs the control number of patron 102 into controller 15 which then establishes a communication link via either the public switch network, a wireless communication network, or a pager network (not shown) to wireless device 12 which then provides a signal or a message to patron 102 indicating the availability of a table. This message, if desired, could also provide other information pertaining to the table, such as its location, etc.

While the patron is waiting for a table, messages can be sent to device 12 from the business establishment. These messages can be, for example, specials of the day, menus, coupons for special pricing, music or other entertainment. One or more of these messages could be a bidirectional communication. For example, a message could say, “We are featuring a certain drink or hors d'oeuvre today. The price is $4.95. Do you wish to order?”Patron 102 then could choose to answer “yes,” “no” or ignore the message. Any reply message would be communicated over a bidirectional link back through the network to controller 15 which would then take the necessary action to insure that the request of patron 102 is performed.

While the system is shown in conjunction with a restaurant setting, any merchandise (or service) that a patron is waiting for can be the subject of the system. FIG. 2A shows, for example, an embodiment 20, in which pharmacy 21 has drive-up window 201. Patron 202 is in his/her vehicle waiting for service. Patron 202 has wireless device 22 which can communicate via RFID or NF communication via input device 24 to register an identification number, such as the calling number of wireless device 22. Alternatively, the calling number can be registered verbally with a person located at pharmacy 21, or the calling number could be registered from a remotely located patron by having that patron call in and verbally present the calling number. If desired, a caller ID or other device could provide the identification of the wireless device of the remote patron.

In on embodiment, the calling identification could be from memory 204 of controller 25 (FIG. 2B) or from a remote system, such as remote system 220 which can be, for example, the system shown in the above identified copending application entitled, “SYSTEM AND METHOD FOR COORDINATING PAYMENT IDENTIFICATION SYSTEMS.”

In operation, using system 20 a prescription (Rx) or other merchandise desired from pharmacy 21 would be entered into controller 25 as well as into the normal pharmaceutical system (not shown) of establishment 21. The Rx can be called in by a physician and attached to the prescription would be the patron identification number. Controller 25 operates in conjunction with the pharmacy system, to cross-link the patron identification, as obtained from the doctor, with the patron's calling identification number and with a code number (if desired). An alternate method of delivering a Rx to establishment 21 is, of course, by physically hand carrying the Rx to an attendant, who would then register the patron's calling identification in association with a code number.

The patron then is free to leave the establishment or do other shopping in the establishment or elsewhere and from time to time messages can be delivered to the patron using, for example, the code number, with respect to other services available, such as specials, coupons, rebates, etc.

At the time when the Rx becomes available, the code number associated with the Rx is communicated to controller 25 (FIG. 2B) which, in one embodiment, has computer 203, memory 204, message store 26, voice-to-text device 27 and text-to-speech device 28 operating in association therewith. When the code number of the available Rx arrives at controller 25, controller 25 then retrieves from memory the patron's calling number, such as the calling number of wireless device 23 for patron 203. A proper message is then selected from message store 206 for communication via a communication link to patron device 23. This communication link can be established locally from establishment 21 or it can be established from remote system 220.

In some instances during the filling process of the Rx the pharmacist may require additional information about the patient or a clarification of the patient's birth date or other information. If the information is available, for example, in memory 204 then upon initiation of a request for the information the information can be provided from memory. In some situations, the request for additional information will be sent from controller 25 to the patron; such as patron 203 via wireless device 23 on a bidirectional link under control of the assigned control code. The patron could be asked for a birth date, an address, or other information. The patron then can communicate the information, either using a touch pad or verbally back to the pharmacist. The verbal communications could be, if desired, translated by voice-to-text device 27.

When patron 203's Rx is ready, a communication is sent from message store 26 through the system to wireless device 23 so that patron 203 can drive up to window 201 to retrieve his/her filled Rx. As the patron is approaching window 201, wireless device 203 could identify itself, for example, via RFID or NF detector 24, and the proper Rx would be ready when patron 203 arrives at window 201. If desired, when patron 203 is notified that the Rx (or other merchandise) is available a price could be included in the message and the patron given the opportunity to authorize payment for the merchandise at that time. This authorization could be under control of the system and method discussed in the above-identified U.S. Patent Application, “SYSTEM AND METHOD FOR COORDINATING PAYMENT IDENTIFICATION SYSTEMS.”

Again, it should be pointed out that while the inventive concepts have been discussed with respect to a pharmacy, any type of establishment can utilize the concepts discussed herein so that a patron can register (or have registered) his/her calling identification and when the merchandise is ready the patron will be notified. While the patron is waiting for such notification, other messages can be delivered to the patron pertaining to services available, either at the establishment or in conjunction with the desires of the patron.

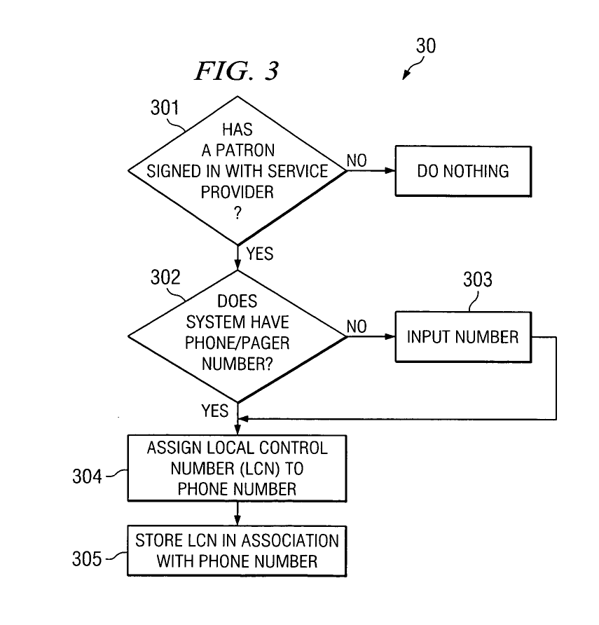

FIG. 3 shows one embodiment of flow chart 30 illustrating the processes of the inventive concepts. Process 301 determines whether a patron has signed in with a service provider. The service provider can be a restaurant, a pharmacy, or any other type of commercial environment where notification of an event is important. Process 302 determines whether the system already has a calling phone or pager number of the wireless device used by the patron. If the system does not already have that information, then process 303 controls the input of that calling information number. This could be by RFID or NF communication, caller ID, verbal with a voice-to-text conversion, (such as speech-to-text converter 27, FIG. 2B).

Process 304 assigns a local control number (LCN) to the phone number. Note that process 304 is not necessary and the system could, if desired, use the actual phone number or caller identification number of the wireless device. For ease of discussion herein it will be assumed that an LCN is utilized. The LCN is stored in association with the phone number via process 305. This storage could be, for example, in memory 204, FIG. 2B, of controller 25 under control of PC 203, but any other system, either local to the physical location of the patron or the place of establishment or in a remote system, such as system 220, FIG. 2A could be used.

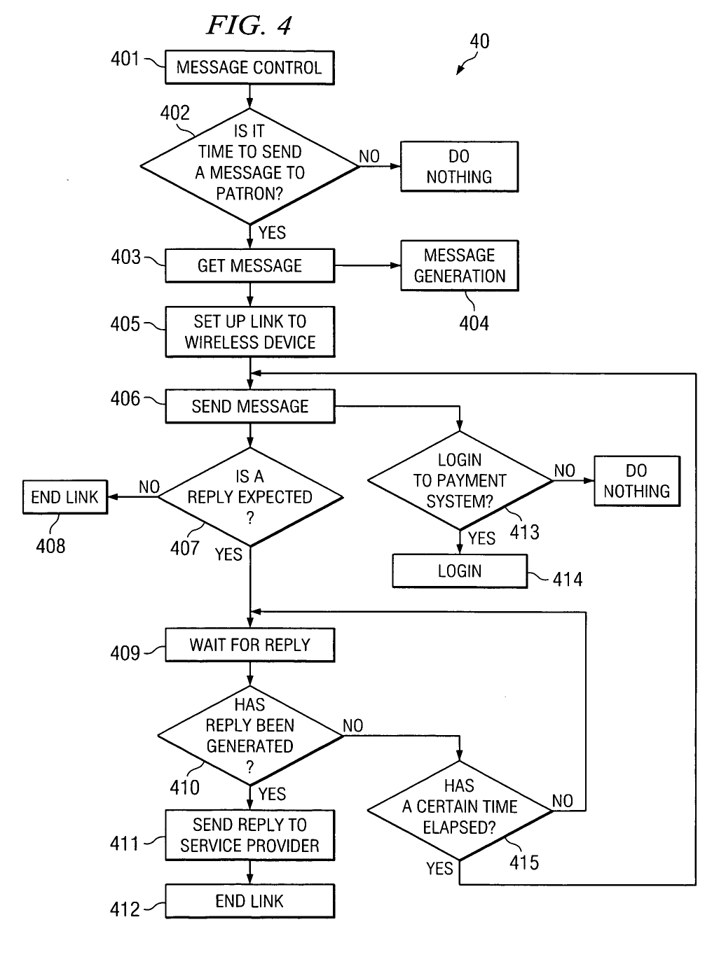

FIG. 4 shows an embodiment 40 of a process for receiving messages and notifications and communicating those messages to a patron from time to time. Process 401 is the message control which determines which messages are to be sent at a given time. These messages can be prerecorded and selected by identification number or they could be input into the system live by a host/hostess, pharmacist, or other establishment member and converted if desired to speech via text-to-speech device 28, FIG. 2B.

Process 402 determines if it is time to send a message to a patron. This determination can be, for example, based on the fact that an Rx is filled or that other merchandise or service is available. The time of the message can be controlled such that, for example, if an Rx is filled in the middle of the night, the notification will not go out until morning.

Process 403, in conjunction with process 404, generates the message and/or retrieves it from a data store and sets up a link to the wireless device via process 405 under control of controller 25, FIG. 2B. The message is then sent via process 406 via either the public switched network, internet connection, packed switched network or otherwise, in accordance with the calling identification number provided during the initial registration period (process 30, FIG. 3).

Process 407 determines if a reply is expected, i.e., bidirectional communication has been set up. If not, then the original message link is terminated via process 408. However, if a reply is expected, then process 409, in conjunction with process 410, determines if a reply has been generated and if so then the reply is sent (process 411) and the link is ended (process 412). Note that process 410 can be established such that if a reply is not generated within a certain time a repeat message is sent to the patron to try to establish a bidirectional communication so as to obtain a reply message under control of process 415.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A paging system comprising:
means for registering with a service provider a calling identity of a wireless device belonging to a patron of said service provider; and
means controlled by said service provider for using said registration to provide said patron, via said wireless device, with messages pertaining to products available from said service provider, said messages provided during a time when said patron is awaiting service from said service provider.

2. The system of claim 1 further comprising:
means for coupling at least one of said registrations with a service desired by the patron associated with said one registration; and
means controlled by said service provider for using said registration to provide said patron, via said wireless device, a notification that said coupled service is currently available.

3. The system set forth in claim 1 wherein at least one of said messages is a bi-directional communication.

4. The system of claim 1 wherein said registering means comprises at least of the following: key entry by a host/hostess at an establishment; RFID entry of said calling number; NF entry of said calling number; entry of said calling number from records maintained by a database; entry of said calling number based on a cross-reference to a reservation made for said patron.

5. The system of claim 1 further comprising:
means for assigning each such registered calling number an identity code different from said calling identity; and
means responsive to receipt of said identity code for sending a message to said wireless device using said calling code.

6. The system of claim 5 wherein said assigning means assigns an identity code based on at least one of the following: random number, portion of said calling identity, precoded calling number for said patron, association of patron with a central billing system where the identity code comes from the central billing system, order of registration, a desired service identifier.

7. The system of claim 5 wherein said sending means sends said number from at least one location selected from the following: location where said calling identity is registered; from a location remote from said location where said calling identity is registered.

8. The system of claim 1 wherein said registering means is located at a place of business, said registering means comprising:
means, including control system input means, for accepting by a person at said place of business said calling number from a patron; and wherein said sending means comprises:
means for dialing said calling number over a public switched network; and
means for sending said message over an established connection to said patron's wireless device.

9. The system of claim 8 wherein said message is selected from the list of: voice message; text message, control signal message.

10. The system of claim 1 further comprising:
means controlled by said registration means for facilitating payment of said services via said patron's wireless device.

11. An announcement method for use in a business environment in which patrons must wait for service, said method comprising:
accepting from a patron who is required to wait for a service a calling number of a personal wireless device of said patron; and
while said patron is waiting for said service, providing to said patron via said personal wireless device messages specific to said business environment.

12. The method of claim 11 further comprising:
sending, when said service becomes available, a notification of said availability to said personal wireless device.

13. The method of claim 12 further comprising:
arranging for payment of said services from said personal wireless device based upon said notification.

14. The method of claim 11 wherein some of said specific messages are bidirectional.

15. The method of claim 11 wherein said messages are sent over a public network without regard to where said patron is located at the time said message is sent.

16. The method of claim 11 wherein said accepting comprises:
entering said calling number into a system; and
said system providing a local ID associated with said entered number.

17. The method of claim 16 wherein said specific messages and said notification is communicated over a link to said personal wireless device using said ID as an input.

18. The method of claim 11 wherein said specific message is delivered from a location remote from a physical location of said business environment.

19. The method of claim 11 wherein said notification is delivered from a location remote from a physical location of said business environment.

20. The method of claim 7 wherein said accepting comprises:
associating said patron with a specific calling number from a database of patron calling numbers.

21. The method of claim 11 wherein said calling number accepting is performed as a result of a match between a wireless device and said patron.

22. The method of claim 11 wherein said calling number accepting is performed as a result of at least one of the following: RFID, NF communication, establishment of a communication link from said personal device to a control system of said business environment.

23. The method of claim 12 wherein said specific message is delivered over a public switched communication system.

24. A notification system comprising:
a system establishing a correlation between a patron's communication device and an item of commerce desired by said patron;
a message control device; and
a controller operative for selecting at least one message from said message control device for delivery to a patron communication device while said patron is waiting for said desired item of commerce.

25. The system of claim 24 wherein said controller is further operable for sending a notification message to said patron when said desired item of commerce is available.

26. The system of claim 25 wherein said item of commerce is at least one of the items selected from the list of: a seat in a restaurant; a Rx at a pharmacy, merchandise ordered from a store.

27. The system of claim 24 wherein said correlation system comprises an RFID reader.

28. The system of claim 24 wherein said correlation system comprises an NF reader reader.
